(19) United States
(12) Patent Application Publication
(10) Pub. No.: US 2018/0230049 A1
(43) Pub. Date: Aug. 16, 2018

(54) DOWNHOLE OPTICAL FIBER WITH ARRAY OF FIBER BRAGG GRATINGS AND CARBON-COATING

(71) Applicants: Paul Francis Wysocki, Blacksburg, VA (US); Ajit Balagopal, Blacksburg, VA (US); Christopher Howard Lambert, Blacksburg, VA (US); Daniel Scott Homa, Blacksburg, VA (US)

(72) Inventors: Paul Francis Wysocki, Blacksburg, VA (US); Ajit Balagopal, Blacksburg, VA (US); Christopher Howard Lambert, Blacksburg, VA (US); Daniel Scott Homa, Blacksburg, VA (US)

(73) Assignee: Baker Hughes Incorporated, Houston, TX (US)

(21) Appl. No.: 15/431,032

(22) Filed: Feb. 13, 2017

(51) Int. Cl. C03C 25/62; C03B 37/03; C03C 25/10; G02B 6/02

(52) U.S. Cl. CPC C03C 25/6233; C03B 37/032; C03C 25/109; C03C 25/106; E21B 47/00; C03C 25/6226; G02B 6/02395; G02B 6/02152; G02B 2006/02157; C03C 25/1065

(57) ABSTRACT

A method for producing a protected optical fiber with distributed sensors includes heating an optical fiber preform and drawing the heated optical fiber preform to form a drawn optical fiber. The method also includes coating the drawn optical fiber with a carbon coating after the optical fiber is drawn to provide a carbon coated optical fiber and then writing a series of fiber Bragg gratings (FBGs) into the carbon coated optical fiber to provide a carbon coated optical fiber with FBGs. The method further includes coating the carbon coated optical fiber with FBGs with one or more layers of a polymer to provide the protected optical fiber with distributed sensors, wherein the heating, drawing, carbon coating the drawn optical fiber, writing, coating the carbon coated optical fiber are performed in that sequence while the protected optical fiber is being produced.

### BACKGROUND

Boreholes are drilled into earth formations for various purposes such as hydrocarbon production, geothermal production, and carbon dioxide sequestration. A distributed sensor system may be disposed in a borehole to sense one or more parameters at various locations within the borehole. One type of distributed sensor system includes an optical fiber having a series of fiber Bragg gratings (FBGs) etched within the fiber. Each FBG contains a series of lines of different optical index of refraction and a prescribed period to reflect a particular wavelength of light. As a value of a sensed parameter changes, spacing between index lines of the FBG at the location of the parameter being sensed will change as well. An optical interrogator in optical communication with the optical fiber can detect the spacing changes and the corresponding location. With this information, a change in the value of the parameter being sensed can be estimated. Unfortunately, the environment downhole may be subject to extremes including very high temperatures and pressures and damaging chemicals. Hence, it would be well received in the drilling and production industries if methods were developed for economically producing distributed optical fiber sensors that can withstand the downhole environment.

### BRIEF SUMMARY

Disclosed is a method for producing a protected optical fiber with distributed sensors. The method includes: heating an optical fiber preform; drawing the heated optical fiber preform to form a drawn optical fiber; coating the drawn optical fiber with a carbon coating after the optical fiber is drawn to provide a carbon coated optical fiber; writing a series of fiber Bragg gratings (FBGs) into the carbon coated optical fiber to provide a carbon coated optical fiber with FBGs; and coating the carbon coated optical fiber with FBGs with one or more layers of a polymer to provide the protected optical fiber with distributed sensors; wherein the heating, drawing, carbon coating the drawn optical fiber, writing, coating the carbon coated optical fiber are performed in that sequence while the protected optical fiber is being produced.

Also disclosed is a system to produce a protected optical fiber with distributed sensors. The system includes: a draw furnace configured to heat an optical fiber preform so that an optical fiber can be drawn; a drawing device configured to draw an optical fiber from the optical fiber preform and wind the protected optical fiber with distributed sensors on a capstan; a carbon coating applicator configured to coat the drawn optical fiber with carbon to provide a carbon coated optical fiber; a fiber Bragg grating writing apparatus configured to write a series of fiber Bragg gratings (FBGs) in the carbon coated optical fiber to provide a carbon coated optical fiber with FBGs; a polymer coating applicator configured to coat the carbon coated fiber with FBGs with one or more layers of a polymer to provide the protected optical fiber with distributed sensors; wherein the carbon coating applicator, fiber Bragg grating writing apparatus, and polymer coating applicator are configured to process the drawn optical fiber in that sequence before the protected optical fiber with distributed sensors is wound on the capstan of the drawing device.

### BRIEF DESCRIPTION OF THE DRAWINGS

The following descriptions should not be considered limiting in any way. With reference to the accompanying drawings, like elements are numbered alike:

FIG. 1 is a cross-sectional view of an embodiment of an optical fiber sensing system for sensing parameters at various locations in a borehole penetrating the earth;

FIG. 2 depicts aspects of a protected optical fiber with fiber Bragg grating sensors;

FIG. 3 is a cross-sectional view of a draw tower for producing an optical fiber with distributed sensors having a carbon coating and a polymer coating over the carbon coating; and

FIG. 4 is a flow chart for a method for producing an optical fiber with distributed sensors.

### DETAILED DESCRIPTION

A detailed description of one or more embodiments of the disclosed apparatus and method presented herein by way of exemplification and not limitation with reference to the figures.

Disclosed are embodiments of methods for producing a protected optical fiber having distributed sensors. Each of the sensors is a fiber Bragg grating (FBG) that is etched into the optical fiber. The protected optical fiber is configured to be disposed in a borehole penetrating the earth. Directly over the optical fiber is a coating of carbon that is configured to prevent hydrogen ingress into the optical fiber and thus prevent hydrogen induced optical loss. Because the carbon coating is thin and susceptible to damage, one or more coatings of polymer are disposed over the carbon coating to protect the carbon coating and the optical fiber. With this combination of elements, the resulting optical fiber is able to successfully operate in a downhole environment.

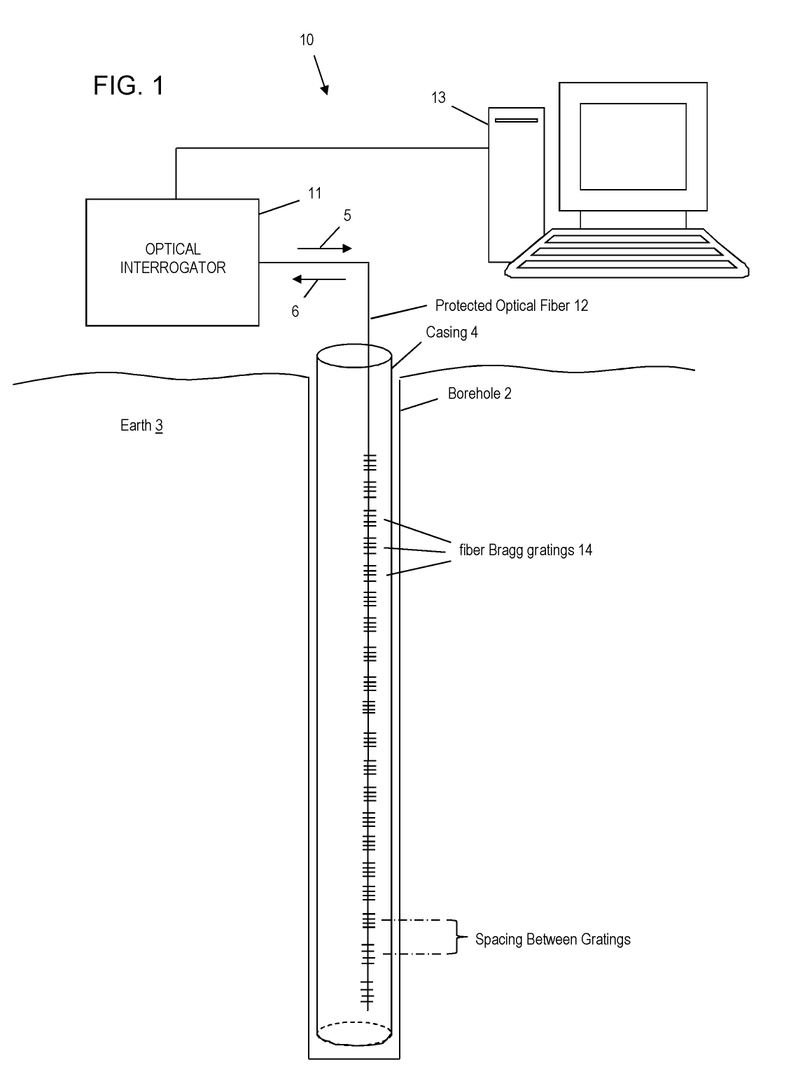

FIG. 1 illustrates a simplified schematic diagram of an optical distributed sensing system 10. The optical system 10 includes an optical interrogator 11 in optical communication with a protected optical fiber 12. The protected optical fiber 12 includes a series of sensors referred to as fiber Bragg gratings 14. Each fiber Bragg grating 14 is configured to act as a filter to reflect a fraction of incoming light at or near a resonant frequency characteristic of the fiber Bragg grating and to let the light of the other frequencies pass. Imposing a force or temperature change on the grating will cause the grating to distort and cause a shift in the resonant wavelength (or corresponding frequency). By measuring the amount of the shift, the amplitude of the force or parameter causing the force, such as mechanical strain or change in temperature, can be measured. For example, the following equation may be used to correlate the shift in resonant wavelength to an applied strain or a change in temperature of the grating:

[Δλ_{B}/λ_{B}]=(1−pₑ) [symbol] +(α∧+αₙ)ΔT

where Δλ_{B}/λ_{B} is the relative shift in the Bragg wavelength due to an applied strain (ϵ) and a change in temperature (ΔT), pₑ is the strain optic coefficient, αΛ is the thermal expansion coefficient of the optical fiber, and αₙ is the thermo-optic coefficient. The distance between adjacent FBGs in a sensor array is dependent on several variables and one of skill in the art would understand how to select the proper spacing for the processing technique being used and the desired application. In one or more embodiments, all of the FBGs in one optical fiber in the present disclosure are written at the same wavelength (i.e., have the same optical reflective properties) and at a relatively low reflective strength (or reflectivity) and use Optical Frequency Domain Reflectometry to interrogate them all. In contrast, in many conventional distributed optical sensing systems, the FBGs are written at different wavelengths and have a relatively higher reflective strength (e.g., at least 100 times higher) and may be interrogated by a frequency multiplexed interrogator.

Non-limiting embodiments of the types of measurements performed by the fiber Bragg gratings include pressure, temperature, strain, force, acceleration, shape, and chemical composition. The FBG is naturally sensitive to either strain or temperature changes. For the measurement of other parameters, a transducer may be required to convert the parameter of interest into either a strain or temperature change. In non-limiting embodiments, the length of each fiber Bragg grating may be in a range of from a few millimeters to about two centimeters depending on the desired response characteristics of the gratings.

The protected optical fiber 12 in FIG. 1 is shown affixed to a casing 4 that is disposed in a borehole 2 penetrating the earth 3. The casing 4 represents any equipment, apparatus, or material that the optical fiber 12 may be used to perform measurements on. Additionally, environmental conditions in the borehole may be monitored or measured using the optical fiber 12.

The optical interrogator 11 is configured to measure the shift in the resonant wavelength (or corresponding resonant frequency), if any, in each fiber Bragg grating and to determine the location in the optical fiber of each fiber Bragg grating being interrogated. In a frequency multiplexed interrogator system, the location of a particular FBG is often known only by noting the original location of the FBG with a wavelength near the measured value. In order to measure the resonant wavelength shifts and grating locations, the optical interrogator 11 is configured to transmit input light 5 into the optical fiber 12 and to receive reflected light 6 (also referred to as return light). The transmitted input light 5 and the reflected light 6 are transmitted and processed in accordance with any of the methods known in the art such as Optical Frequency Domain Reflectometry (OFDR), Incoherent Optical Frequency Domain Reflectometry (IOFDR), or broadband reflectometry with frequency-domain multiplexing in non-limiting embodiments. In the case of frequency-domain multiplexing, different FBGs must be resonant at different wavelengths in order to interrogate all of them at once.

Still referring to FIG. 1, a computer processing system 13 is coupled to the optical interrogator 11. The computer processing system 13 is configured to process the reflected light 6. For example, the computer processing system 13 can perform a fast Fourier transform (FFT) on received reflected light 6. Further, the computer processing system 13 can convert the magnitude of the resonant frequency shift into a parameter of interest such as temperature or strain for example using a mathematical relationship between parameter and the magnitude of the resonant frequency shift. The mathematical relationship can be determined by analysis and/or testing. The computer processing system 13 can be standalone or incorporated into the optical interrogator 11. Once the values of the parameter of interest are determined, it can be displayed to a user via a display or printer, it can be recorded for future use, or it can be input into an algorithm requiring that parameter for execution.

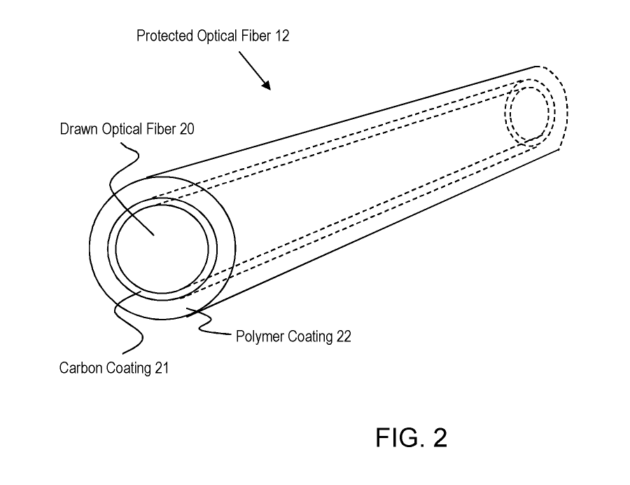

FIG. 2 depicts aspects of the protected optical fiber 12 having distributed FBGs 14. The protected optical fiber 12 includes a drawn optical fiber 20 that is configured to convey light to and from the distributed FBGs 14. In one or more embodiments, the diameter of the core optical fiber is 125 microns. A carbon coating 21 coats the drawn optical fiber 20. The carbon coating 21 prevents ingress of hydrogen into the core optical fiber 20 thus preventing hydrogen induced optical loss. In general, the carbon coating 21 is thin having a thickness of about 0.01 microns in one or more embodiments. One or more layers of a polymer coating 22 coats the one or more layers of the carbon coating 21. Because the carbon coating 21 is thin, the one or more layers of the polymer coating 22 provides physical protection to both the carbon coating 21 and the drawn optical fiber 20. The carbon coating 21 itself provides protection from hydrogen ingress. Consequently, the carbon and polymer coatings in this embodiment constitute the protection for the fiber in harsh environments. In one or more embodiments, the polymer coating 22 is a polyimide that requires thermal curing at about at least 500° C., noting that higher temperatures may speed up the thermal curing. The thermal curing may be performed in a curing furnace. In one or more embodiments, each polyimide layer has a thickness in a range of 2-5 microns. In one or more embodiments, the polymer coating 22 is an acrylate that requires curing in ultra-violet (UV) light. In one or more embodiments, the polymer coating 22 is a silicone that requires curing in UV light. In one or more embodiments, multiple layers of different polymers or the same polymer may be used to coat the carbon coating 21. For example, a silicone layer may first coat the carbon coating 21 to provide cushioning followed by one or more acrylate layers.

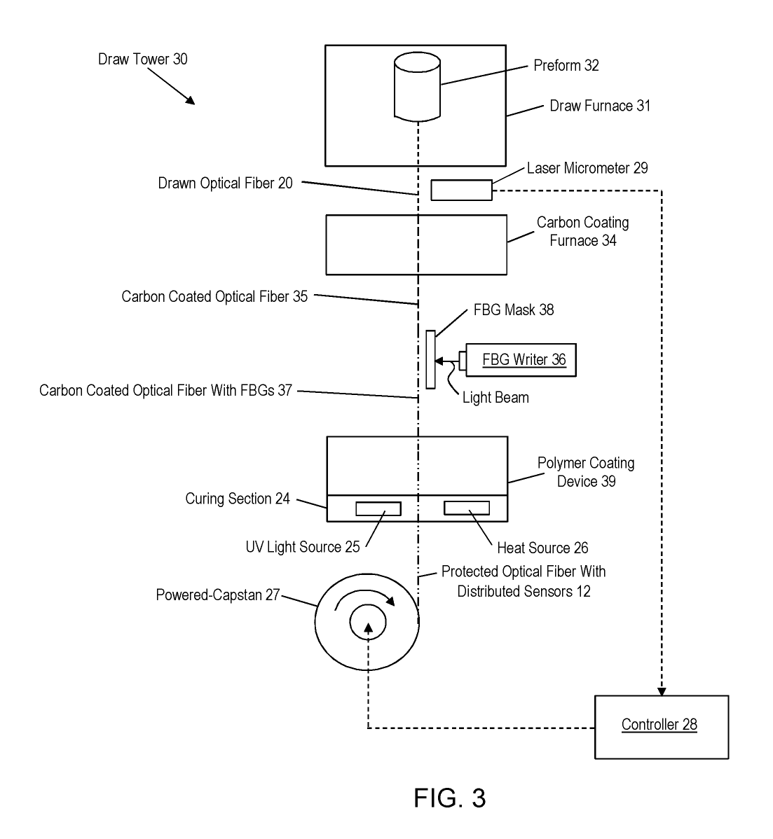

FIG. 3 is a cross-sectional view of a draw tower 30 for producing the protected optical fiber with distributed sensors 12. The draw tower 30 includes a draw furnace 31 configured to heat a preform 32 from which the drawn optical fiber 20 is drawn. In one or more embodiments, the preform 32 is doped with a UV light-sensitive material such as Germanium (Ge). In one or more embodiments, the temperature of the draw furnace 31 is in a range of 1900-2100° C. The draw tower 30 also includes a carbon coating furnace 34 configured to apply the carbon coating 21 to the core optical fiber 20. In one or more embodiments, a carbon containing gas such as acetylene is heated and causes a high temperature reaction that deposits a layer of carbon on the core optical fiber 20 that itself is at a temperature of 950° C. One skilled in the art will realize that the heat to raise the temperature of the fiber and/or the carbon containing gas may be leftover heat from the draw furnace 31. The deposited carbon may include graphite, graphene, and/or a diamond-like carbon structure. The carbon may be deposited in a single layer or multiple layers. Drawn from the carbon coating furnace 34 is a carbon coated optical fiber 35.

The draw tower 30 further includes a FBG writing apparatus 36 configured to write a series of fiber Bragg gratings (FBGs) in the carbon coated optical fiber 35 to provide a carbon coated optical fiber with FBGs 37. In one or more embodiments, the FBG writing apparatus 36 is a UV laser. In one or more embodiments, each FBG is written in one pulse of the UV laser through a FBG mask 38, which writes all of the refractive index discontinuities for that FBG at the same time using the one pulse of UV light.

The draw tower 30 further includes a polymer coating device 39 configured to apply the polymer coating 22 to the carbon coated optical fiber 35 with FBGs 37 to provide the protected optical fiber with distributed sensors 23. In general, the polymer coating 22 is applied at a temperature of less than or equal to 100° C. In one or more embodiments, the temperature is approximately 30° C. The polymer coating device 39 may include a curing section 24 configured to cure the polymer coating 22 after it is applied. The curing section 24 may include a UV light source 25 for UV curing and/or a heat source 26 for thermal curing. In one or more embodiments, the heat source 26 is configured to provide the thermal curing at 900° C.

The draw tower 30 further includes a powered-capstan 27 configured to draw the drawn optical fiber 20 from the preform 32. A controller 28 is configured to control one or more capstan parameters of the powered-capstan 27. Non-limiting embodiments of the capstan parameters include drawing or pulling tension and drawing speed. A laser micrometer 29 is configured to sense the diameter of the drawn optical fiber 20 and provide input to the controller 28 in order to control the one or more capstan parameters to achieve a desired diameter of the drawn optical fiber 20. While the embodiment of FIG. 3 illustrates the laser micrometer 29 being disposed between the draw furnace 31 and the carbon coating furnace 34, the laser micrometer 29 can be disposed between other stages of the draw tower 30 such as after the carbon coating furnace 34 for example.

The draw tower 30 may further include other instruments and controls (not shown) that are deemed necessary to produce the protected optical fiber with distributed sensors 23 is a continuous process such as from heating the optical fiber preform 32 to curing the polymer coating 22. For example, the other instruments may include an optical pyrometer for sensing temperatures in one or more of the furnaces to ensure that the one or more furnaces are at the proper temperature or a tension measuring device to measure the tension on the fiber during fiber draw. These other control aspects may also be incorporated into the controller 28.

A distance between each of the process stages may be selected in order to provide proper cooling of the optical fiber to the desired temperature for the next stage before the next stage of the process is started. In that the thermal mass of the optical fiber between each of the stages is low, unreasonably long distances between the stages are generally not required. A temperature sensor (not shown) may be used to ensure the optical fiber is at the proper temperature before the start of each stage of the process. The distance between each of the stages may be determined by testing and/or analysis.

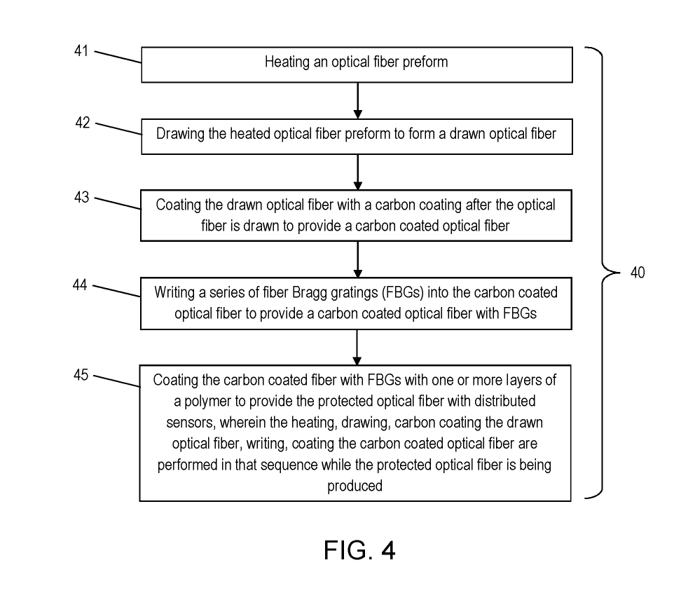

FIG. 4 is a flow chart for one example of a method 40 for producing a protected optical fiber with distributed sensors. Block 41 calls for heating an optical fiber preform. The optical fiber preform may be heated with a draw furnace to an appropriate temperature for melting the selected optical fiber preform.

Block 42 calls for drawing the heated optical fiber preform to form a drawn optical fiber. The drawn optical fiber may be drawn using a powered-capstan at a selected tension and/or speed to provide the drawn optical fiber at a desired diameter.

Block 43 calls for coating the drawn optical fiber with a carbon coating after the optical fiber is drawn to provide a carbon coated optical fiber. The carbon coating may be applied using a carbon coating furnace at an optimized temperature to produce the desired protection from hydrogen ingress.

Block 44 calls for writing a series of fiber Bragg gratings (FBGs) into the carbon coated optical fiber to provide a carbon coated optical fiber with FBGs. In one or more embodiments, the writing of each FBG having multiple index of refraction discontinuities is performed by UV light exiting a mask illuminated by a UV laser in one pulse. On the draw tower, the fiber is moving, so only a single short pulse of UV light can be used to write each FBG. To write a FBG at a typical wavelength, the optical index must be modulated at a spatial period of about 1 micron and the pattern must not move by a fraction of that pattern period during the single shot FBG pulse. For the draw tower moving fiber at 1 m/s or more, this requires that the entire writing process for a single FBG occur in 10 ns or less in a single short pulse. Hence, continuous wave (CW) or quasi-CW Q switched UV lasers cannot be used to provide adequate power to write high reflectivity FBGs. Even without carbon coating, the strongest FBG written on a tower may be about less than −40 dB peak reflectivity. Optical focusing using a cylindrical lens or other lens design might be used to enhance the intensity of the UV light impinging on the fiber, which at this location might be only 125 um in diameter. This can increase the strength of a FBG that might be written in a single pulse to, for example, −25 dB peak reflectivity. (The term “peak reflectivity” relates to the magnitude of a reflection signal compared to the travel or incoming signal as a function of wavelength that gives a maximum value.) Testing and analysis has demonstrated that it is acceptable to use large arrays (100 s to 10000 s of FBGs) of weakly reflective FBGs (e.g., about 0.01% of peak reflection magnitude) for distributed sensing applications downhole, even if the phase quality of the FBGs, or the spectral distribution is not ideal.

Block 45 calls for coating the carbon coated optical fiber with FBGs with one or more layers of a polymer to provide the protected optical fiber with distributed sensors. The one or more layers of polymer may be applied with a polymer coating device. Block 45 may also include curing the one or more layers of polymer after they are applied. The process for producing the protected optical fiber with distributed sensors includes performing the heating, drawing, coating the drawn optical fiber with carbon, writing the FBGs, coating the carbon coated optical fiber with a polymer in that specific temporal sequence while the protected optical fiber is being produced.

It is noted that one of the challenges to the successful performance of this process is the relative temperatures of the different processes combined with the optical requirements. It is not inherently apparent that it is possible to successfully achieve all four processes (see blocks 42-45), drawing, carbon coating, FBG writing and polymer coating in a single inline process. The process of drawing a silica-based optical fiber is performed at approximately 1900° C., and successful (able to stop hydrogen ingress) carbon coating is applied at approximately 950° C. FBGs are advantageously written by UV light in Ge containing fibers at near room temperature of approximately 30° C. It is well known that such FBGs once written and taken to elevated temperatures are reduced in strength by a process known as annealing and can be completely eliminated when experiencing high temperatures for some time. Certainly, one skilled in the art might recognize that exposure of such an FBG to 1900° C. or 950° C. would reduce the optical strength or completely eliminate the FBG. Similarly, it is well known that polymer coatings have limited temperature ranges of use. A polyimide coating typical is rated for field use to 300° C. while an acrylate coating typically is rated to 150° C. Both such coatings are completely destroyed by exposure to 1900° C. or 950° C. temperatures. Additionally, it should be well understood by those skilled in the art that carbon coating produces substantial optical attenuation for ultraviolet light required to write FBGs in a Ge-doped or P-doped silica-based fiber. Writing by any other method has not been successfully demonstrated to occur fast enough to be performed in line on a draw tower. Similarly, most polymer coatings significantly attenuate UV light as well as distort the phase of relationship necessary to write high quality FBGs. Polymer coatings that both can be successfully used at high temperatures and transmit UV to some extent for writing FBGs are not available. Even coatings that transmit UV to some extent distort the phase relationships required by FBGs to some degree.

Given these limitations, one would expect that FBG writing must occur after both drawing and carbon coating to avoid thermal annealing, but must be before carbon coating and polymer coating to avoid optical UV attenuation and phase distortion. Polymer coating most naturally must occur last, but must be performed before any mechanical contact is made to the fiber structure, in order to avoid damage and strength degradation. One might propose carbon coating after FBG writing, but this will wash out the FBGs. One might suggest stripping the polymer coating shortly after it is applied, writing FBGs and then recoating with polymer inline. However, this is impractical due to the mechanical limitation of handling bare fiber described above and the speed of the process. In short, at first consideration, one skilled in the art would recognize the inherent difficulty in achieving all four of the operations successfully. However, as disclosed herein, for some applications, this is in fact possible if the operations are performed exactly in the order prescribed in the method 40, namely drawing, carbon coating, FBG writing and polymer coating from the top of the tower to the bottom in that temporal order. This is in fact possible if the application can tolerate a relatively weak FBG reflectivity, like −40 to −50 dB (with respect to strong gratings not written through a carbon coating), which is indeed the case for certain systems. It has been demonstrated that, despite the optical attenuation of UV light for writing FBGs caused by carbon coating and any FBG annealing caused by the process of polymer coating, it is possible to write strong enough FBGs with single UV laser shots on a draw tower after carbon coating and before polymer coating. It is believed that no other order of operations can successfully achieve this result.

The method 40 may also include controlling the tension and/or rotational speed of the powered-capstan using a controller that receives input from a laser micrometer that is configured to measure a diameter of the core optical fiber in order to draw the core optical fiber at a desired diameter. The controller may also control other aspects of producing the protected optical fiber with distributed sensors using the draw tower. For example, the controller may also control temperatures of the various processes for producing the protected optical fiber. Further, the controller may control the writing of the FBGs in accordance with selected FBG parameters such as distance between lines of each grating and distance between adjacent FBGs.

The disclosure herein provides several advantages. One advantage is that producing the protected optical fiber with distributed sensors during one continuous draw process can be economical compared to alternative methods. For example, reworking an already produced polymer coated optical fiber would require stripping the polymer coating the write the FBGs and then recoating the optical fiber, a time consuming and expensive process. Another advantage is that the produced protected optical fiber with distributed sensors is robust enough with the carbon and polymer coatings to be able to withstand exposure to the harsh downhole environment that has in general high temperatures and hydrogen-rich materials.

Set forth below are some embodiments of the foregoing disclosure:

### Embodiment 1

A method for producing a protected optical fiber with distributed sensors, the method comprising: heating an optical fiber preform; drawing the heated optical fiber preform to form a drawn optical fiber; coating the drawn optical fiber with a carbon coating after the optical fiber is drawn to provide a carbon coated optical fiber; writing a series of fiber Bragg gratings (FBGs) into the carbon coated optical fiber to provide a carbon coated optical fiber with FBGs; and coating the carbon coated optical fiber with FBGs with one or more layers of a polymer to provide the protected optical fiber with distributed sensors; wherein the heating, drawing, carbon coating the drawn optical fiber, writing, coating the carbon coated optical fiber are performed in that sequence while the protected optical fiber is being produced.

### Embodiment 2

The method according to any prior embodiment, wherein the optical preform is heated in a range of 1900-2100° C.

### Embodiment 3

The method according to any prior embodiment, wherein a temperature of the optical fiber when the carbon coating is applied is less than the temperature of the optical fiber preform when drawn.

### Embodiment 4

The method according to any prior embodiment, wherein the optical fiber is in a temperature range of 900-1000° C. when the carbon coating is applied.

### Embodiment 5

The method according to any prior embodiment, wherein writing the series of FBGs is performed when a temperature of the carbon coated optical fiber is less than the temperature of the optical fiber when the carbon coating was applied.

### Embodiment 6

The method according to any prior embodiment, wherein the temperature of the carbon coated optical fiber is less than or equal to 300° C. when the series of FBGs is written into the optical fiber.

### Embodiment 7

The method according to any prior embodiment, wherein coating the carbon coated fiber with FBGs with one or more layers of a polymer is performed when a temperature of the carbon coated optical fiber with FBGs is less than or equal to 100° C.

### Embodiment 8

The method according to any prior embodiment, wherein the polymer comprises polyimide and the method further comprises thermal curing of the polyimide.

### Embodiment 9

The method according to any prior embodiment, wherein the polymer comprises acrylate and the method further comprises curing the acrylate with ultra-violet light.

### Embodiment 10

The method according to any prior embodiment, wherein the polymer comprises silicone and the method further comprises curing the silicone with ultra-violet light.

### Embodiment 11

The method according to any prior embodiment, wherein the polymer comprises a layer of acrylate over the layer of silicone and the method further comprises curing the acrylate with ultra-violet light.

### Embodiment 12

The method according to any prior embodiment, wherein the optical fiber is drawn using a powered-capstan and the heating, drawing, coating the optical fiber, writing, coating the carbon coated optical fiber are performed before the protected optical fiber with distributed sensors is wound on the powered-capstan.

### Embodiment 13

The method according to any prior embodiment, further comprising selecting a distance between: the drawing and the coating the drawn optical fiber with a carbon coating; the coating the drawn optical fiber with a carbon coating and the writing a series of fiber FBGs into the carbon coated optical fiber; and/or the writing a series of fiber FBGs into the carbon coated optical fiber and the coating the carbon coated optical fiber with FBGs with one or more layers of a polymer to provide proper cooling.

### Embodiment 14

The method according to any prior embodiment, wherein writing a series of FBGs into the carbon coated optical fiber comprises writing each FBG in the series of FBGs using a single pulse of light traveling through an FBG mask.

### Embodiment 15

A system to produce a protected optical fiber with distributed sensors, the system comprising: a draw furnace configured to heat an optical fiber preform so that an optical fiber can be drawn; a drawing device configured to draw an optical fiber from the optical fiber preform and wind the protected optical fiber with distributed sensors on a capstan; a carbon coating applicator configured to coat the drawn optical fiber with carbon to provide a carbon coated optical fiber; a fiber Bragg grating writing apparatus configured to write a series of fiber Bragg gratings (FBGs) in the carbon coated optical fiber to provide a carbon coated optical fiber with FBGs; a polymer coating applicator configured to coat the carbon coated fiber with FBGs with one or more layers of a polymer to provide the protected optical fiber with distributed sensors; wherein the carbon coating applicator, fiber Bragg grating writing apparatus, and polymer coating applicator are configured to process the drawn optical fiber in that sequence before the protected optical fiber with distributed sensors is wound on the capstan of the drawing device.

### Embodiment 16

The system according to any prior embodiment, wherein the polymer coating applicator comprises a curing device configured to cure the polymer after the polymer is applied to the carbon coated optical fiber with FBGs.

### Embodiment 17

The system according to any prior embodiment, wherein the curing device comprises at least one of a curing furnace and source of ultra-violet light.

### Embodiment 18

The system according to any prior embodiment, wherein a distance between: the drawing and the coating the drawn optical fiber with a carbon coating; the coating the drawn optical fiber with a carbon coating and the writing a series of fiber FBGs into the carbon coated optical fiber; and/or the writing a series of fiber FBGs into the carbon coated optical fiber and the coating the carbon coated optical fiber with FBGs with one or more layers of a polymer provides proper cooling.

### Embodiment 19

The system according to any prior embodiment, wherein the fiber Bragg grating writing apparatus is configured to write each FBG in the series of FBGs using a single pulse of light traveling through an FBG mask.

In support of the teachings herein, various analysis components may be used, including a digital and/or an analog system. For example, the optical interrogator 11, the computer processing system 13, and/or the controller 28 may include digital and/or analog systems. The system may have components such as a processor, storage media, memory, input, output, communications link (wired, wireless, optical or other), user interfaces (e.g., a display or printer), software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply, cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured.

The flow diagram depicted herein is just an example. There may be many variations to this diagram or the steps (or operations) described therein without departing from the spirit of the invention. For example other operations such as cooling may be performed at certain points without changing the specific disclosed sequence of operations with respect to each other. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the spirit and scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for producing a protected optical fiber with distributed sensors, the method comprising:
heating an optical fiber preform;
drawing the heated optical fiber preform to form a drawn optical fiber;
coating the drawn optical fiber with a carbon coating after the optical fiber is drawn to provide a carbon coated optical fiber;
writing a series of fiber Bragg gratings (FBGs) into the carbon coated optical fiber to provide a carbon coated optical fiber with FBGs; and
coating the carbon coated optical fiber with FBGs with one or more layers of a polymer to provide the protected optical fiber with distributed sensors;
wherein the heating, drawing, carbon coating the drawn optical fiber, writing, coating the carbon coated optical fiber are performed in that sequence while the protected optical fiber is being produced.

2. The method according to claim 1, wherein the optical preform is heated in a range of 1900-2100° C.

3. The method according to claim 1, wherein a temperature of the optical fiber when the carbon coating is applied is less than the temperature of the optical fiber preform when drawn.

4. The method according to claim 3, wherein the optical fiber is in a temperature range of 900-1000° C. when the carbon coating is applied.

5. The method according to claim 1, wherein writing the series of FBGs is performed when a temperature of the carbon coated optical fiber is less than the temperature of the optical fiber when the carbon coating was applied.

6. The method according to claim 5, wherein the temperature of the carbon coated optical fiber is less than or equal to 300° C. when the series of FBGs is written into the optical fiber.

7. The method according to claim 1, wherein coating the carbon coated fiber with FBGs with one or more layers of a polymer is performed when a temperature of the carbon coated optical fiber with FBGs is less than or equal to 100° C.

8. The method according to claim 1, wherein the polymer comprises polyimide and the method further comprises thermal curing of the polyimide.

9. The method according to claim 1, wherein the polymer comprises acrylate and the method further comprises curing the acrylate with ultra-violet light.

10. The method according to claim 1, wherein the polymer comprises silicone and the method further comprises curing the silicone with ultra-violet light.

11. The method according to claim 1, wherein the polymer comprises a layer of acrylate over the layer of silicone and the method further comprises curing the acrylate with ultra-violet light.

12. The method according to claim 1, wherein the optical fiber is drawn using a powered-capstan and the heating, drawing, coating the optical fiber, writing, coating the carbon coated optical fiber are performed before the protected optical fiber with distributed sensors is wound on the powered-capstan.

13. The method according to claim 12, further comprising selecting a distance between: the drawing and the coating the drawn optical fiber with a carbon coating; the coating the drawn optical fiber with a carbon coating and the writing a series of fiber FBGs into the carbon coated optical fiber; and/or the writing a series of fiber FBGs into the carbon coated optical fiber and the coating the carbon coated optical fiber with FBGs with one or more layers of a polymer to provide proper cooling.

14. The method according to claim 1, wherein writing a series of FBGs into the carbon coated optical fiber comprises writing each FBG in the series of FBGs using a single pulse of light traveling through an FBG mask.

15. A system to produce a protected optical fiber with distributed sensors, the system comprising:
a draw furnace configured to heat an optical fiber preform so that an optical fiber can be drawn;
a drawing device configured to draw an optical fiber from the optical fiber preform and wind the protected optical fiber with distributed sensors on a capstan;
a carbon coating applicator configured to coat the drawn optical fiber with carbon to provide a carbon coated optical fiber;
a fiber Bragg grating writing apparatus configured to write a series of fiber Bragg gratings (FBGs) in the carbon coated optical fiber to provide a carbon coated optical fiber with FBGs;
a polymer coating applicator configured to coat the carbon coated fiber with FBGs with one or more layers of a polymer to provide the protected optical fiber with distributed sensors;
wherein the carbon coating applicator, fiber Bragg grating writing apparatus, and polymer coating applicator are configured to process the drawn optical fiber in that sequence before the protected optical fiber with distributed sensors is wound on the capstan of the drawing device.

16. The system according to claim 15, wherein the polymer coating applicator comprises a curing device configured to cure the polymer after the polymer is applied to the carbon coated optical fiber with FBGs.

17. The system according to claim 16, wherein the curing device comprises at least one of a curing furnace and source of ultra-violet light.

18. The system according to claim 15, wherein a distance between: the drawing and the coating the drawn optical fiber with a carbon coating; the coating the drawn optical fiber with a carbon coating and the writing a series of fiber FBGs into the carbon coated optical fiber; and/or the writing a series of fiber FBGs into the carbon coated optical fiber and the coating the carbon coated optical fiber with FBGs with one or more layers of a polymer provides proper cooling.

19. The system according to claim 15, wherein the fiber Bragg grating writing apparatus is configured to write each FBG in the series of FBGs using a single pulse of light traveling through an FBG mask.
